(19) United States
(12) Patent Application Publication
(10) Pub. No.: US 2026/0310452 A1
(43) Pub. Date: Oct. 8, 2026

(54) LANGUAGE MODEL-BASED CODE REPOSITORY TRANSFORMATION FOR TARGET TECHNOLOGY PLATFORM

(71) Applicant: AT&T Intellectual Property I, L.P., Atlanta, GA (US)

(72) Inventors: Bobby Mander, Holmdel, NJ (US); Satyen Jhaveri, Dallas, TX (US)

(21) Appl. No.: 19/098,836

(22) Filed: Apr. 2, 2025

(51) Int. Cl. G06F 8/73; G06F 8/10; G06F 8/41

(52) U.S. Cl. CPC G06F 8/73; G06F 8/10; G06F 8/447

(57) ABSTRACT

A processing system may generate explanatory documentation for a software package associated with a source technology platform by applying a first prompt to a machine learning language model requesting a generation of the explanatory documentation for a contents of the software package and generating the explanatory documentation via the model in accordance with the first prompt. The processing system may further generate a migration description set by applying a plurality of prompts to the model, where the explanatory documentation and system documentation system documentation describing available functions of a target technology platform are provided along with each prompt and generating a plurality of migration description factors via the model in accordance with the prompts. The processing system may then generate a user story by applying a second prompt to the model, where the explanatory documentation, the system documentation, and the migration description set are provided along with the second prompt.

The present disclosure relates generally to machine learning language models and telecommunication network operations, and more specifically to methods, computer-readable media, and apparatuses for generating via a machine learning language model at least one user story for a transformation of a software package to a target technology platform based on explanatory documentation for the software package and a migration description set generated via the machine learning language model.

### BACKGROUND

Over time, legacy software applications grow more expensive to operate and maintain. These large systems may have millions of lines of code written by developers who have left or retired from an organization. In addition, legacy code may be poorly documented, with an organization lacking expertise in the structure and function(s) of the legacy code. In many cases, these software applications, or software packages, are replicated and migrated to strategic platforms with the latest technologies, which may be less expensive to maintain, may integrate with other current technologies, such a containerization, virtual machines, software defined networking, etc., and so forth.

### SUMMARY

The present disclosure describes methods, computer-readable media, and apparatuses for generating via a machine learning language model at least one user story for a transformation of a software package to a target technology platform based on explanatory documentation for the software package and a migration description set generated via the machine learning language model. For instance, in one example, a processing system including at least one processor may generate an explanatory documentation for content of a software package associated with a source technology platform. In one example, the generating of the explanatory documentation may include applying a first prompt to a machine learning language model, where the first prompt requests a generation of the explanatory documentation for the content of the software package associated with the source technology platform and generating the explanatory documentation via the machine learning language model in accordance with the first prompt. The processing system may further generate a migration description set using: the explanatory documentation and a system documentation describing available functions of a target technology platform. For instance, the generating of the migration description set may include applying a plurality of prompts to the machine learning language model, where the explanatory documentation and the system documentation is provided to the machine learning language model along with each prompt of the plurality of prompts, and generating a plurality of migration description factors of the migration description set via the machine learning language model in accordance with the plurality of prompts. For instance, each of the plurality of prompts may request a generation of one of the plurality of migration description factors, where the plurality of migration description factors includes: a first migration description factor including a summary of the software package, a second migration description factor including a mapping of target sources for inputs of the software package in the target technology platform, and a third migration description factor including a mapping of target destinations for outputs of the software package in the target technology platform. The processing system may then generate at least one user story based upon the explanatory documentation, the system documentation, and the migration description set. For example, the generating of the at least one user story may include applying a second prompt to the machine learning language model that requests a generation of the at least one user story, where the explanatory documentation, the system documentation, and the migration description set may be provided to the machine learning language model along with the second prompt.

### BRIEF DESCRIPTION OF THE DRAWINGS

The present disclosure can be readily understood by considering the following detailed description in conjunction with the accompanying drawings, in which:

FIG. 1 illustrates an example of a system related to the present disclosure;

FIG. 2 illustrates an example process flow for transforming a software package in accordance with the present disclosure;

FIG. 3 illustrates an example of a portion of explanatory documentation for a software package, in accordance with the present disclosure;

FIG. 4 illustrates a table of example migration description sets, in accordance with the present disclosure;

FIG. 5 illustrates an example accuracy assessment that may be generated by a machine learning language model, in accordance with the present disclosure;

FIG. 6 illustrates an example user story that may be generated by a machine learning language model, in accordance with the present disclosure;

FIG. 7 illustrates an example of generated code that may be output by a machine learning language model, in accordance with the present disclosure;

FIG. 8 illustrates a flowchart of an example method for generating via a machine learning language model at least one user story for a transformation of a software package to a target technology platform based on explanatory documentation for the software package and a migration description set generated via the machine learning language model; and

FIG. 9 illustrates a high-level block diagram of a computing device specially programmed to perform the functions described herein.

To facilitate understanding, identical reference numerals have been used, where possible, to designate identical elements that are common to the figures.

### DETAILED DESCRIPTION

The present disclosure broadly discloses methods, non-transitory (i.e., tangible or physical) computer-readable media, and apparatuses for generating via a machine learning language model at least one user story for a transformation of a software package to a target technology platform based on explanatory documentation for the software package and a migration description set generated via the machine learning language model. In particular, examples of the present disclosure include an artificial intelligence (AI)/machine learning (ML)-based system that provides data summarization and high-precision translation of software code, polices, and/or configurations. Examples of the present disclosure may add new contexts and may accommodate any form of data so that new problem spaces can be handled easily. In addition, examples of the present disclosure may provide both an intuitive user Interface (UI) and robust application programming interface (API) that scales well across a large user base, all operating independently and adding many independent contexts (e.g., new data loads along with prompts that help with the interpretation of such data). To further illustrate, in one example, the present disclosure may provide an AI/ML system that is configured to provide an end-to-end transfer/porting of legacy software packages to a target technology platform, where a software package can include all components necessary for a software application to perform its intended function(s)/task(s). For instance, this can include the code of the software application in one or more files. This can also include libraries, e.g., functions called, etc., source data sets, polices that may be referred to by software applications, and so forth.

In one example, the present disclosure may include a processing system implementing/hosting a Python application that uses Jupyter Notebooks, OpenAI APIs, Flask, and HTML/Javascript to provide both a user interface (UI) and a server side to handle all functionality. In one example, the present disclosure may use a machine learning (ML) language model, e.g., a “large language model” (LLM), such as ChatGPT-4 LLM that provides 32k tokens for the prompt which allows the system to effectively learn new use cases. To further illustrate, the application may be organized into Python scripts and notebooks with a software layer for the UI and a separate layer for the server side. The UI layer may use Flask and Javascript to provide a seamless webpage interface. Configuration files may be used to extend functionality of the application without requiring any code changes to prior existing functionalities.

In accordance with the present disclosure, the AI/ML-based system for translation of legacy software packages to a target technology platform may be data agnostic and may accept any structured or unstructured data as context input. In addition, examples of the present disclosure may scale up to handle any number of independent use cases simultaneously with rapid extensibility to tackle new problem domains. In one example, the present disclosure may employ an agent-based framework, allowing sequential or parallel tasks to utilize a core LLM while collaborating on more complex problems that include multiple steps to complete.

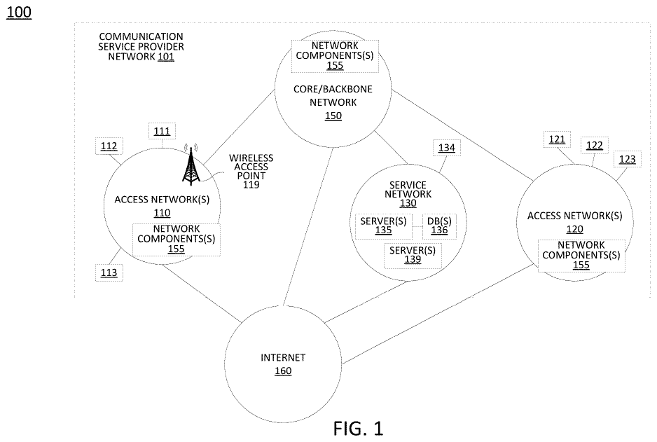

Notably, interacting with a generative MLM manually may provide limited gains to a user, and may not be able to scale well for larger problems that involve significantly more work to be performed by the tool. However, examples of the present disclosure provide multi-stage functionality to load new contexts and to solve new porting/translation tasks as described in greater detail below. As just one example, the AI/ML-based system for translation of legacy software packages to a target technology platform of the present disclosure may be used for policy translation from a legacy system/platform to a modern, target technology platform. One or more examples of a proper translation may be provided to the AI/ML-based system, which may then perform additional translations at scale. For instance, having a legacy system with tens of thousands of policies, the AI/ML-based system of the present disclosure may avoid significant redundancy, eliminate rounds of testing, and reduce errors and inconsistencies, particularly where the original developers and their expertise are no longer available. These and other aspects of the present disclosure are discussed in greater detail below in connection with the examples of FIGS. 1-9.

To aid in understanding the present disclosure, FIG. 1 illustrates an example system 100 comprising a plurality of different networks in which examples of the present disclosure may operate. Communication service provider network 101 may comprise a core network and/or backbone network 150 with components for telephone services, Internet services, and/or video services (e.g., triple-play services, etc.) that are provided to customers (broadly “subscribers”), and to peer networks. In one example, core/backbone network 150 may combine core network components of a cellular network with components of a triple-play service network. For example, communication service provider network 101 may functionally comprise a fixed-mobile convergence (FMC) network, e.g., an IP Multimedia Subsystem (IMS) network. In addition, core/backbone network 150 may functionally comprise a telephony network, e.g., an Internet Protocol/Multi-Protocol Label Switching (IP/MPLS) backbone network utilizing Session Initiation Protocol (SIP) for circuit-switched and Voice over Internet Protocol (VoIP) telephony services. Communication service provider network 101 may also further comprise a broadcast video network, e.g., a cable television provider network or an Internet Protocol Television (IPTV) network, as well as an Internet Service Provider (ISP) network. With respect to video/television service provider functions, core/backbone network 150 may include one or more video servers for the delivery of video content, e.g., a broadcast server, a cable head-end, a video-on-demand (VoD) server, and so forth. For example, core/backbone network 150 may comprise a video super hub office, a video hub office and/or a service office/central office.

In one example, access/service networks 110 and 120 may provide one or more services to subscribers and/or customer premises, such as voice, data, video, and/or wireless access services, virtual local area network (VLAN) services, and so forth. For instance, access/service networks 110 and 120 may each comprise a Digital Subscriber Line (DSL) network, a broadband cable access network, a Local Area Network (LAN), a cellular or non-cellular wireless access network, and the like. For example, access/service networks 110 and 120 may transmit and receive communications between endpoint devices 111-113, endpoint devices 121-123, and data center network 130 (broadly a service network), and between core/backbone network 150 and endpoint devices 111-113 and 121-123 relating to voice telephone calls, communications with web servers via the Internet 160, and so forth. Access/service networks 110 and 120 may also transmit and receive communications between endpoint devices 111-113, 121-123 and other networks and devices via Internet 160. In another example, one or both of the access/service networks 110 and 120 may comprise an ISP network external to communication service provider network 101, such that endpoint devices 111-113 and/or 121-123 may communicate over the Internet 160, without involvement of the communication service provider network 101. Endpoint devices 111-113 and 121-123 may each comprise customer premises equipment (CPE), user equipment (UE), and/or other endpoint device types, such as a telephone, e.g., for analog or digital telephony, a mobile device, such as a cellular smart phone, a laptop, a tablet computer, etc., a router (e.g., a customer edge (CE) router), a gateway, a desktop computer, a plurality or cluster of such devices, a television (TV), e.g., a “smart” TV, or a set-top box (STB).

In one example, the access/service networks 110 and 120 may be different types of access networks. In another example, the access/service networks 110 and 120 may be the same type of access network. In one example, one or more of the access/service networks 110 and 120 may be operated by the same or a different service provider from a service provider operating the communication service provider network 101. For example, each of the access/service networks 110 and 120 may comprise an Internet service provider (ISP) network, a cable access network, and so forth. In another example, each of the access/service networks 110 and 120 may comprise a cellular access network, implementing such technologies as: global system for mobile communication (GSM), e.g., a base station subsystem (BSS), GSM enhanced data rates for global evolution (EDGE) radio access network (GERAN), or a UMTS terrestrial radio access network (UTRAN) network, among others, where core/backbone network 150 may provide cellular core network functions, e.g., of a public land mobile network (PLMN)-universal mobile telecommunications system (UMTS)/General Packet Radio Service (GPRS) core network, or the like. For instance, access/service network(s) 110 may include at least one wireless access point (AP) 119, e.g., a cellular base station, such as an eNodeB, or gNB, a non-cellular wireless access point (AP), such as an Institute of Electrical and Electronics Engineers (IEEE) 802.11 (Wi-Fi) access point, or the like. In still another example, access/service networks 110 and 120 may each comprise a home network or enterprise network, which may include a gateway to receive data associated with different types of media, e.g., television, phone, and Internet, and to separate these communications for the appropriate devices. For example, data communications, e.g., Internet Protocol (IP) based communications may be sent to and received from a router in one of the access/service networks 110 or 120, which receives data from and sends data to the endpoint devices 111-113 and 121-123, respectively.

In this regard, it should be noted that in some examples, endpoint devices 111-113 and 121-123 may connect to access/service networks 110 and 120 via one or more intermediate devices, such as a home or enterprise gateway and/or router, e.g., where access/service networks 110 and 120 comprise cellular access networks, ISPs and the like, while in another example, endpoint devices 111-113 and 121-123 may connect directly to access/service networks 110 and 120, e.g., where access/service networks 110 and 120 may comprise local area networks (LANs), enterprise networks, and/or home networks, and the like.

In one example, communication service provider network 101 may also include one or more network components 155 (e.g., in core/backbone network 150 and/or access/service networks 110 and 120). Network components 155 may include various physical components of communication service provider network 101. For instance, network components 155 may include various types of optical network equipment, such as an optical network terminal (ONT), an optical network unit (ONU), an optical line amplifier (OLA), a fiber distribution panel, a fiber cross connect panel, and so forth. Similarly, network components 155 may include various types of cellular network equipment, such as a mobility management entity (MME), a mobile switching center (MSC), an eNodeB, a gNB, a base station controller (BSC), a baseband unit (BBU), a remote radio head (RRH), an antenna system controller, and so forth. In one example, network components 155 may alternatively or additionally include voice communication components, such as a call server, an echo cancellation system, voicemail equipment, a private branch exchange (PBX), etc., short message service (SMS)/text message infrastructure, such as an SMS gateway, a short message service center (SMSC), or the like, video distribution infrastructure, such as a media server (MS), a video on demand (VoD) server, a content distribution node (CDN), and so forth. Network components 155 may further include various other types of communication network equipment such as a layer 3 router, e.g., a provider edge (PE) router, an integrated services router, etc., an Internet exchange point (IXP) switch, and so on. In one example, network components 155 may further include virtual components, such as a virtual machine (VM), a virtual container, etc., software defined network (SDN) nodes, such as a virtual mobility management entity (vMME), a virtual serving gateway (vSGW), a virtual network address translation (NAT) server, a virtual firewall server, or the like, and so forth. In addition, in one example, network component 155 may include measurement systems, such as network probe devices or the like, to test connectivity across core/backbone network 150, access/service network(s) 110, and/or access/service network(s) 120 (e.g., end-to-end and/or within a selected network segment, etc.). In addition, for ease of illustration, various components of communication service provider network 101 are omitted from FIG. 1.

Still other network components 155 may include a database of assigned telephone numbers, a database of basic customer account information for all or a portion of the customers/subscribers of the communication service provider network 150, a cellular network service home location register (HLR), e.g., with current serving base station information of various subscribers, and so forth, a Simple Network Management Protocol (SNMP) trap, or the like, a billing system, a customer relationship management (CRM) system, a trouble ticket system, an inventory system (IS), an ordering system, an enterprise reporting system (ERS), an account object (AO) database system, and so forth. In addition, other network components 155 may include, for example, a layer 3 router, a short message service (SMS) server, a voicemail server, a video-on-demand server, a server for network traffic analysis, a database server/database system, and so forth. It should be noted that in one example, a communication network component may be hosted on a single server, while in another example, a communication network component may be hosted on multiple servers, e.g., in a distributed manner.

In accordance with the present disclosure, network components 155 may comprise “network resources” of various network resource types, which may also include services provided and/or hosted via network components 155, e.g., enterprise communication services, such as a virtual private network (VPN) service, a virtual local area network (VLAN) service, a Voice over Internet Protocol (VoIP), a software defined-wide area network (SD-WAN) service, an Ethernet wide area network E-WAN service, and so forth. Alternatively, or in addition, network resources may include interfaces or ports associated with such services, such as a customer edge (CE) router or PBX-to-time division multiplexing (TDM) gateway interface, a Border Gateway Protocol (BGP) interface (e.g., between BGP peers), and so forth. For instance, a CE router, PBX, or the like may be homed to one or several provider edge (PE) routers or other edge component(s).

In one example, the data center network 130 (broadly a service network) may comprise a local area network (LAN), or a distributed network connected through permanent virtual circuits (PVCs), virtual private networks (VPNs), and the like for providing data and voice communications. In one example, the data center network 130 may comprise one or more devices for providing services to subscribers, customers, and/or users. For example, communication service provider network 101 may provide a cloud storage service, web server hosting, and other services. As such, data center network 130 may represent aspects of communication service provider network 101 where infrastructure for supporting such services may be deployed. In one example, the data center network 130 may alternatively or additionally comprise one or more devices supporting operations and management of communication service provider network 101. For instance, in the example of FIG. 1, server(s) 139 may include higher level services/applications such as a database of assigned telephone numbers, a database of basic customer account information for all or a portion of the customers/subscribers of the communication service provider network 101, a billing system, a customer relationship management (CRM) system, a trouble ticket system, an ordering system, an enterprise reporting system (ERS), an account object (AO) database system, a network inventory system, a network topology/mapping system, a network provisioning system, a unified data repository (UDR), and so forth. In one example, server(s) 139 may alternatively or additionally comprise one or more of the types of network components 155 described above.

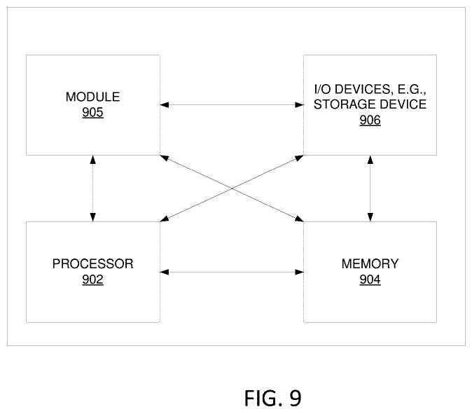

In addition, data center network 130 may include one or more servers 135 which may each comprise all or a portion of a computing device or system, such as computing system 900, and/or processing system 902 as described in connection with FIG. 9 below, specifically configured to perform various steps, functions, and/or operations for generating via a machine learning language model at least one user story for a transformation of a software package to a target technology platform based on explanatory documentation for the software package and a migration description set generated via the machine learning language model, as described herein. For example, one of the server(s) 135, or a plurality of the servers 135 collectively, may perform operations in connection with the example method 800, or as otherwise described herein.

In addition, it should be noted that as used herein, the terms “configure,” and “reconfigure” may refer to programming or loading a processing system with computer-readable/computer-executable instructions, code, and/or programs, e.g., in a distributed or non-distributed memory, which when executed by a processor, or processors, of the processing system within a same device or within distributed devices, may cause the processing system to perform various functions. Such terms may also encompass providing variables, data values, tables, objects, or other data structures or the like which may cause a processing system executing computer-readable instructions, code, and/or programs to function differently depending upon the values of the variables or other data structures that are provided. As referred to herein a “processing system” may comprise a computing device including one or more processors, or cores (e.g., as illustrated in FIG. 9 and discussed below) or multiple computing devices collectively configured to perform various steps, functions, and/or operations in accordance with the present disclosure.

In one example, data center network 130 may also include one or more databases (DBs) 136, e.g., physical storage devices integrated with server(s) 135 (e.g., database servers), attached or coupled to the server(s) 135, and/or in remote communication with server(s) 135 to store various types of information in connection with examples of the present disclosure. For example, DB(s) 136 may be configured to receive and store network topology data, including the type(s) of network resources/network elements (e.g., both physical and virtual), the locations of such network resources, the connectivity between resources, the allocation of such resources to sub-nets, tracking areas, or the like, and so forth. In one example, the network topology information/data may include or may be cross-referenced to network inventory data, such as, for physical network resources, the manufacture date, the purchase date, the deployment date, the last serviced date and/or a service history, identities of the service technician(s), an incident/event list (e.g., for past network events associated with the network resource), a serial number, a model number, a version number, a software version, and so forth. In one example, the network topology data may comprise a network graph, or network graph database. For instance, nodes in the graph/graph database may represent network resources, network zones, etc., where some links/edges may represent physical links, or logical paths over physical links, while other links/edges may represent logical relationships, such as a virtual network function (VNF) being instantiated on a particular network function virtualization infrastructure (NFVI) physical element, a network resource being a component of a particular sub-net or tracking area, etc.

In addition, DB(s) 136 may be configured to receive and store network operational data, including performance indicator data (e.g., “key performance indicators” (KPIs)), such as: utilization and/or availability levels of network resources, configuration settings and/or parameters of such network resources, alarm data, and so forth. For instance, such data may be collected from various network components 155 reporting to server(s) 135 and/or to DB(s) 136, such as routers, RAN elements, cellular core network components, video distribution components, storage servers, content distribution network nodes, etc. It should be noted that some or all of such information (network topology and/or network operational data) may be contained in other network databases/systems, such as one or more of an active and available inventory (A&AI) database, a network inventory database, a call detail records (CDR) repository, or the like (e.g., represented by server(s) 139 and/or various network components 155).

Alternatively, or in addition, DB(s) 136 may be configured to receive and store customer/subscriber network resource order information (e.g., an additional type or types of network operational data), such as the subscriber/customer identities and other characteristics (e.g., a customer intensity value and/or a customer segment as described herein), the timing of such orders, the quantities of such orders, the type of service(s) ordered, and so forth. Similar to the above, some or all of such information may be contained in other network databases/systems, such as one or more of an authentication, authorization, and accounting (AAA) server/system, an operations support system (OSS), a business support system (BSS), a unified data repository (UDR), or the like. It should be noted that in accordance with the present disclosure, the network topology information/data and/or network operational data stored in DB(s) 136 or elsewhere may be maintained over a period of time. For instance, DB(s) 136 may store respective time series data indicative of different states of a network topology, different utilization and/or assignment levels of various network resources of various types in a given time interval (and over a period of a plurality of time intervals), etc. In one example, data may be segregated by customer segment, network zone, geographic region, and so forth.

In one example, DB(s) 136 may alternatively or additionally comprise a communication network technology documentation repository. For instance, this may include subscriber service documentation, cellular technology standards documentation (e.g., network standards documentation, such as 3GPP technical standards documentation), Internet Engineering Task Force (IETF) standards documents (e.g., RFCs that have status of Internet Standard or Best Current Practice (BCP), or the like), International Telecommunication Union Telecommunication Standardization Sector (ITU-T) recommendations, standards and/or specifications, e.g., Data Over Cable Service Interface Specification (DOCSIS), etc., IEEE standards (e.g., 802.11/Wi-Fi standards, etc., or the like), network operator documentation (e.g., procedures, manuals, best practices, whitepapers, etc.), at least one cellular network-related law or regulation, or the like. For example, the set of available laws and regulations can be previously specified by a system operator in advance. In other words, the documentation repository may not include the entirety of US federal and state statutes, Code of Federal Regulations, and state and local regulations, etc. Rather, the set of laws and regulations may be initially bounded by placing those that are deemed relevant to cellular network technologies in a database of selected laws and regulations. In one example, the network technology documentation in the network technology documentation repository may include computer programming code for configuring various network functions, or the like.

In one example, DB(s) 136 may comprise a code repository or application repository, e.g., for software applications/software packages that may be used for various purposes throughout the communication service provider network 101. For instance, DB(s) 136 may store configuration code for various network functions, such as code to enable one or more of network component(s) 155 to function as a particular type of network function, e.g., a virtual access management function (vAMF), a virtual user plane function (vUPF), a virtual session management function (vSMF), a virtual firewall server, and so forth. In one example, the code repository may store code for various modular functions/applications that may be used for one or multiple types of VNFs, such as code to determine whether a given year is a leap year, code to convert a time recorded in a particular time zone to an equivalent time in a selected time zone, and so forth. In one example, the code may be associated with a first type of technology platform, such as a particular programming language, a particular type of operating system or operating environment, and so forth.

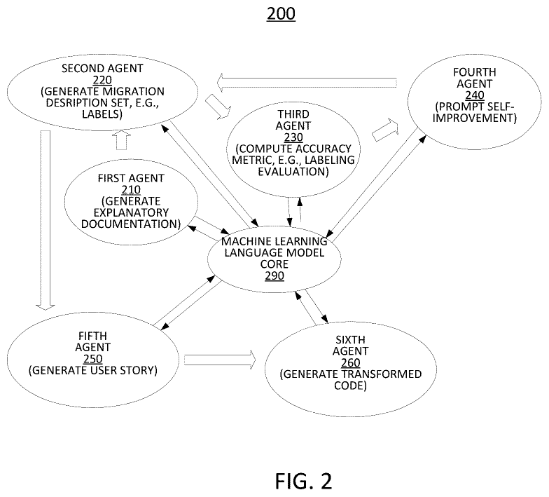

In accordance with the present disclosure some or all of such code may be transformed/ported from a source technology platform to a target technology platform, such as to a different programming language, a different operating system or operating environment (such as a virtualization environment or a particular type of virtualization environment, a containerization environment or a particular type of virtualization environment, a cloud computing environment or a particular type of cloud computing environment, etc.), and so forth. Aspects of such a transformation process are illustrated in the examples of FIGS. 2-7 and described in greater detail below. In one example, the new code/transformed code may also be stored in a code repository of DB(s) 136.

In one example, DB(s) 136 may also store artificial intelligence (AI) models and/or machine learning models (MLMs) that may be trained by, activated, and/or deployed by server(s) 135 in connection with examples of the present disclosure. In one example, server(s) 135 and/or DB(s) 136 may comprise cloud-based and/or distributed data storage and/or processing systems comprising one or more servers at a same location or at different locations. For instance, DB(s) 136, or DB(s) 136 in conjunction with one or more of the servers 135, may represent a distributed file system, e.g., a Hadoop® Distributed File System (HDFS™), or the like. In one example, the one or more of the servers 135 and/or server(s) 135 in conjunction with DB(s) 136 may comprise a generative MLM-based code transformation platform (e.g., a network-based and/or cloud-based service hosted on the hardware of server(s) 135 and/or DB(s) 136).

It should be noted that as referred to herein, a machine learning model (MLM) (or machine learning-based model) may comprise a machine learning algorithm (MLA) that has been “trained” or configured in accordance with input training data to perform a particular service. For instance, an MLM may comprise a deep learning neural network, or deep neural network (DNN), a convolutional neural network (CNN), a recurrent neural network (RNN), a long short-term memory (LSTM) model, a generative adversarial network (GAN), a decision tree algorithm/model, such as gradient boosted decision tree (GBDT) (e.g., XGBoost, XGBR, or the like). In one example, one or more MLMs of the present disclosure may include supervised learning and/or reinforcement learning (e.g., using positive and negative examples after deployment as a MLM), and so forth. In one example, MLAs/MLMs of the present disclosure may be in accordance with an open source library, such as OpenCV, which may be further enhanced with domain-specific training data. In one example, MLMs of the present disclosure may include an ML-based generative model (e.g., a type of generative AI model/system), such as a language model, e.g., a “large language model” (LLM). For instance, an ML-based generative model used in the present examples, e.g., a ML language model, may comprise a generative adversarial network (GAN), a bidirectional encoder representations from transformers (BERT) model (e.g., BERT-Base, BERT-Large, etc.), a generative pre-training (GPT) model (e.g. GPT, GPT-2, GPT-3, or the like), a pathways language model (PaLM) a Language Model for Dialogue Applications (LaMDA) model, or other generative natural language processing (NLP) models. In one example, language models of the present disclosure may comprise an ada text embedding model.

In accordance with the present disclosure, server(s) 135 may comprise a language model agent or language model-based agent, e.g., a LLM agent. In one example, the language model agent, e.g., server(s) 135, may comprise a language model core, also referred to herein as a machine learning (ML) language model, e.g., comprising a LLM or the like. Server(s) 135 may further include a plurality of agent tools, or agent tool interfaces (e.g., application programming interfaces (APIs), webhooks, or the like) to call/interact with various tools, also referred to herein as AI agents. For example, AI agents may include an explanatory documentation generation agent/tool, a labeling/migration description set generation tool, an accuracy/labeling evaluation tool, a prompt self-improvement tool, a user story generation tool, a target code generation tool, and so forth. Other tools may include a retrieval augmented generation (RAG)/vector database search/context retrieval tool, and so forth.

To further illustrate, server(s) 135 may implement a multi-phase/multi-step process which may be handled in a completely automated system. For instance, examples of the present disclosure may provide a language model agent or language model-based agent. For instance, in one example, such a language model agent, or agents, may be implemented by server(s) 135. In this regard, it should be noted that as referred to herein, “AI agents” may refer to AI processes or systems, including a machine learning (ML)-based processes/systems, that are fine-tuned for specific purposes. In one example, the present disclosure may fine tune a machine learning model (MLM), such as a large language model (LLM) (e.g., a generative pre-trained transformer (GPT) model, or the like), to provide high-level instructions to address communication network-specific issues. For instance, such an LLM may be used as a core LLM for a LLM-based agent (also referred to herein as a LLM agent or language model agent) of the present disclosure. In addition, in one example, the present disclosure may further enhance such a fine-tuned LLM to provide concrete actionable instructions, e.g., using specific agent tools.

In one example, a LLM agent of the present disclosure may further include a retrieval augmented generation (RAG) process to extract relevant additional context as supplemental prompt content for the core ML language model. For instance, RAG functionality may be used to extract network equipment and/or network function vendor documentation, network operator internal documents, cellular technology technical standards, such as 3rd Generation Partnership Project (3GPP) technical standards (TS), or the like from a vector store. Alternatively, or in addition, the core ML language model may be fine-tuned, e.g., in a reinforcement learning through AI feedback (RLAF) process. For example, the foregoing produces a known correct context for a given question (or set of similar questions in a group). Thus, RLAF may be implemented by feeding known questions/queries to the core ML language model and then tracking whether, how often, and/or with what percentage of accuracy the core ML language model produces known correct answers. As such, reinforcement learning may be used to promote desired behaviors and hence fine-tune the core ML language model to pick the most concise context for each question. In one example, the present disclosure may further provide a web-based interface, e.g., a graphical user interface (GUI), for network personnel to interact with the LLM agent to submit requests, to obtain outputs, to provide user feedback to continuously improve RAG and other functionalities of the LLM agent, and so forth. In addition, in various examples, the present disclosure may be implemented using the current and/or future tools and technologies, such as using a LangChain framework with Snowflake application programming interface (API), large language model(s) (LLM(s) (such as OpenAI and others), Streamlit user interface (UI) implementation, and so forth.

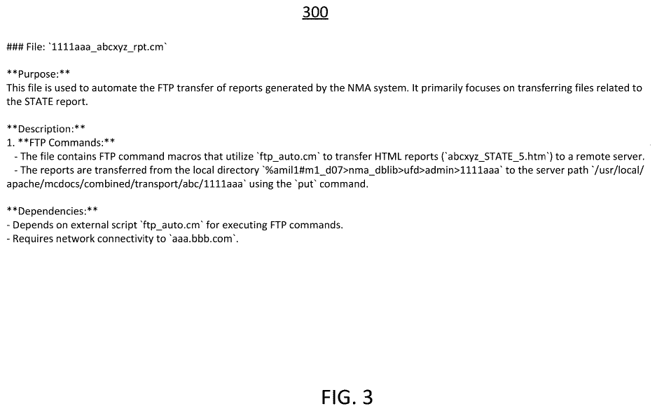

FIG. 2 illustrates additional aspects of the foregoing functionality of server(s) 135 in an example process flow 200. In addition, it should be noted that servers(s) 135 may alternatively or additionally perform various operations as described in connection with FIGS. 3-8, or elsewhere herein. Furthermore, it should be realized that the system 100 may be implemented in a different form than that illustrated in FIG. 1, or may be expanded by including additional endpoint devices, access networks, network elements, application servers, etc. without altering the scope of the present disclosure. As just one example, any one or more of the server(s) 135 and DB(s) 136 may be distributed at different locations, such as in or connected to access/service networks 110 and 120, in another service network connected to Internet 160 (e.g., a cloud computing provider), in core/backbone network 150, and so forth. For instance, DB(s) 136 and/or server(s) 135 may alternatively or additionally be deployed in a public cloud storage and/or computing system, or the like. In addition, although the foregoing is described with respect to a communication network code repository, other, further, and different examples may extend to code for domains beyond communication network management. For instance, this may include transfer of code across video/computer gaming platforms, transfer of code from one type of database records management system to another type of database records management system for financial records, medical records, and so forth. For instance, in each case, the present disclosure may include a ML language model core, e.g., which may be fine-tuned/pre-tuned with respect to the particular domain. In this regard, DB(s) 136 may store any or all of such types of code (and in some cases additional domain-specific knowledge documentation), e.g., where server(s) 135 may provide a generative MLM-based code transformation platform as a service to users/entities external to the network operator itself. Thus, these and other modifications are all contemplated within the scope of the present disclosure.

FIG. 2 illustrates an example code transformation process 200 in accordance with the present disclosure. In particular, the code transformation process 200 may include a plurality of modules and/or tools, e.g., agents 210-260. For instance, agents 210-260 may comprise LLM agents or the like. To further illustrate, the code transformation process may begin with a first agent 210 generating explanatory documentation for a software package. For instance, the software package may include one or more executable files of code, and/or may include one or more libraries or portions of libraries, dependencies, data sets, or other components to enable execution of the code by a processing system to perform one or more intended functions. However, it should be understood that as referred to herein, a software package may include less than all components that may be used to enable execution of a complete functionality. For instance, a “software package” may omit various libraries, which may be handled via a separate transformation process, or via an independent iteration of the example code transformation process 200. Similarly, a software package handled via the example code transformation process 200 may include less than all files that may be part of an executable package, such as for a network function. For example, a configuration file that includes code for determining whether a given year is a leap year may be processed separately from a configuration file that includes code for converting from a time in a local time zone to an equivalent time in a reference time zone, and so forth.

In one example, the first agent 210 may be configured to submit a prompt to the machine learning (ML) language model core 290 along with the software package as additional context for the prompt (e.g., supplemental prompt content/context). It should be noted that the ML language model core 290 may comprise a language model (e.g., a LLM) as described above. In one example, the entire process 200, e.g., including agents 210-260 and the ML language model core 290, may be implemented by a processing system, such as one or more of server(s) 135 of FIG. 1. To further illustrate, the first agent 210 may include a prompt that specifically requests the machine learning (ML) language model core 290 to generate explanatory documentation for a selected source software package. For instance, such a prompt may be: “generate a concise wiki-style text that summaries the software package. Include specific sections for functionalities, inputs, outputs, and dependencies.” In one example, the first agent 210 may be configured to organize multiple files into a single file, to import libraries or library functions into such a single file, and so forth. In one example, the single file may include annotations to indicate a source file for a particular section of code. In one example, the first agent 210 may be configured to chunk the software package (e.g., assembled as a single file) for submission to the ML language model core 290, e.g., as a sequence of submissions of the prompt with the chunks of code as respective supplemental prompt content in compliance with a context size window. For instance, the ML language model core 290 may have a constraint of a maximum context size window of 128,000 tokens (e.g., words, phrases, etc.), or the like.

The resultant explanatory documentation (e.g., an output of the ML language model core 290 in response to such a prompt) may include a wiki-style text that summarizes the software package/repository as a whole, e.g., including one or more of: functionalities, inputs, outputs, and/or dependencies. For example, functionalities may include: sending an alarm on device type XYZ to ticketing system ABC, ticket collecting, ticket enrichment, ticket filtering, etc. Inputs may include inputs to a system from a device itself or human-entered input. These may comprise files, text, API calls, etc. Outputs may comprise what is produced by a repo/software package, such as a ticket, an alarm, a measured or forecast data traffic, etc. Examples of dependencies may comprise libraries being used, technology (or technologies) be used, etc. Alternatively, or in addition, the explanatory documentation may include in-line comments (e.g., in or between lines of code) of one or more files of the software package for better readability. In this regard, FIG. 3 illustrates an example of a portion of explanatory documentation 300 for a software package. For instance, the explanatory documentation 300 may be an output of the ML language model core 290 in response to an example input prompt such as described above (e.g., along with the software package as additional context). In any case, the result/output for the first agent 210 may be an annotated software package with explanatory documentation included/appended.

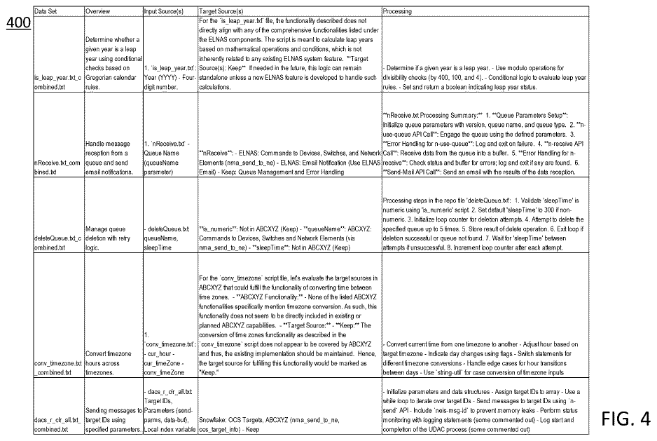

While such an annotated software package may be accessed and read by system operators, the example code transformation process 200 may continue with a second agent 220 being invoked when the first agent 210 completes its task. In particular, the second agent 220 may be configured to generate a migration description set (e.g., a set of labels) using: the explanatory documentation and system documentation describing available functions of a target technology platform as inputs. In this regard, FIG. 4 illustrates a table 400 of example migration description sets (e.g., each row of the table 400 may comprise a migration description set for a respective software package, where each item may be referred to a “label” or “migration descriptor”). For instance, a migration description set may include labels or migration descriptors for identifications of the data set/software package, an overview of the software package (e.g., a one sentence overview, or the like), identification(s) of the input source(s), identification(s) of the target source(s), a processing overview (e.g., how to translate/port the software package from a source technology platform to a target technology platform), and so forth.

For ease of illustration, columns for additional labels/migration descriptions may be omitted from FIG. 4. For instance, additional columns may include columns/labels for: whether a function already exists in the target technology domain, a “process mapping directive,” “output results,” “output mapping directive,” and “alternate migration path.” To further illustrate, the “processing mapping directive” may include a more detailed description of whether the software package should be ported/transformed or not. For instance, if the same functionality appears to already exist in the target domain, it may be unnecessary or redundant to translate/port the software package into the target domain, e.g., for the target technology platform. However, if no such functionality exists, the “process mapping directive” may indicate how to proceed with the outlined steps of the “processing” label/migration description. Similarly, if partial functionality already exists for the target technology platform, the “processing mapping directive” may include a plan to port/translate a portion of the software package, while skipping others that may already exist in the target technology platform. To further illustrate, an example processing mapping directive for the first migration description set may be: “For the file ‘is_leap_year.txt’, the processing mapping directive in ABCXYZ can be marked as: -**Keep**: There is no specific functionality in ABCXYZ that directly matches the leap year determination logic implemented in the ‘is_leap_year.txt’ script. The script relies on internal logic using conditional operations and modulo division to assess leap year status, which is not directly associated with any ABCXYZ functionality or component described in the provided documentation. Therefore, the script's unique processing logic should be retained as it is.”

The “output results” label/migration descriptor may indicate the intended format of the software package (e.g., on screen, email, file, file/screen, logging, or the like). The “output mapping directive” label/migration descriptor may indicate whether to create new outputs for the target domain/technology platform or to integrate with one or more that may already exist in the target domain/technology platform. For instance, an example for the first migration description set may be: “For the repo file ‘is_leap_year.txt’, the output mapping directive indicates whether a year is a leap year, with output results returning true (1) or false (0). As per available ABCXYZ documentation, there isn't a direct mapping of this script's output to any ABCXYZ functionality. Therefore, the output mapping directive for this script should be marked as ‘Keep’ since no equivalent output results in ABCXYZ provide the same functionality. If there are additional repo files not covered in this response, they would need specific analysis based on the ABCXYZ existing and planned functions to determine if their output can be aligned with current or future ABCXYZ capabilities or labeled as ‘Keep’ in the same manner as above.”

It should be noted that the second agent 220 may be configured to submit respective prompts to the ML language model core 290 with the annotated software package as additional context/supplemental prompt content. For example, each column/label/migration descriptor may have a separate prompt that may be used to generate the entry in each column for a particular software package (e.g., for a particular row). For instance, an example prompt of the second agent 220 for the “processing” label/description may be: “Detail all processing steps performed by the software package. Aim for specificity and sequence accuracy. Each step should be understandable independently. Use short phrases instead of full sentences.” In any case, the second agent 220 may therefore generate the example table 400, or one or more rows of the example table 400.

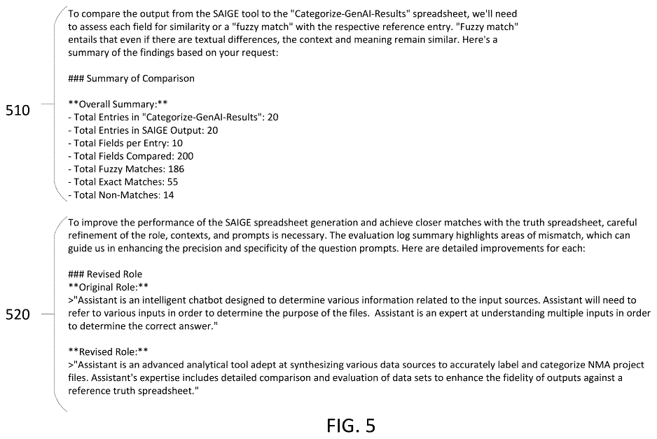

In one example, the third agent 230 may be configured to compute at least one accuracy metric for a migration description set generated via the ML language model core 290 in accordance with the plurality of prompts (e.g., one prompt per column as implemented by the second agent 220). For instance, the third agent 230 may apply yet another prompt to the ML language model core 290 requesting an assessment of similarity, e.g., a “fuzzy match” scoring between results generated by the second agent 220/ML language model core 290 as compared to a truth set (e.g., including one or more human-generated migration description sets and/or one or more migration description sets labeled by a human as being “correct,” “accurate,” or the like). For instance, FIG. 5 illustrates an example accuracy assessment output 510 that may be generated by ML language model core 290 in response to such a prompt from the third agent 230. It should be noted that the migration description set generated by the second agent 220 and the truth set may be provided by the third agent 230 as additional context/supplemental prompt content along with the prompt requesting such accuracy assessment that is submitted by the third agent 230 to the ML language model core 290. In one example, the prompt used by the third agent 230 may request an accuracy metric for the migration description set as a whole and/or for at least one of the migration description factors on an individual basis.

In one example, a fourth agent 240 may be configured to generate a new prompt to perform a same generating task as one of the plurality of prompts implemented by the second agent 220. For example, the fourth agent 240 may be configured to apply still another prompt to the ML language model core 290 requesting the generating of the new prompt, where the one of the plurality of prompts of the agent 220 is provided as additional context/supplemental prompt content along with the present prompt submitted to the ML language model core 290 by the fourth agent 240. For instance, the prompt of the fourth agent 240 may be: “generate me a new prompt with increased accuracy as compared to the following: [add prior prompt text].” In one example, the new prompt may be applied to labeled software packages (e.g., the output(s) of the first agent 210) by the second agent 220, and the resultant migration description sets compared to respective truth sets for accuracy assessment (e.g., via the third agent 230). If the new prompt performs better than the old prompt, the new prompt may then replace the old prompt for use by the second agent 220. An example of such a new, revised, and/or updated prompt is illustrated as the example output 520 of FIG. 5. For instance, the example output 520 may be generated by the ML language model core 290 in response to the prompt from the fourth agent 240. In particular, the output 520 may define a revised role for the prompt that may be used to generate the elements of the input source(s) column of the example table 400 of FIG. 4.

As further illustrated in FIG. 2, a fifth agent 250 may be configured to generate a user story in accordance with the present disclosure. For instance, the fifth agent 250 may submit an additional prompt to the ML language model core 290 that specifically requests the generating of the at least one user story. In one example, the explanatory documentation generated via the first agent 210, the migration description set generate via the second agent 220, and system documentation describing characteristics of the target technology platform may be provided as additional context/supplemental prompt content along with the prompt applied by the fifth agent 250 to the ML language model core 290. In response, the ML language model core 290 may generate at least one user story based upon the explanatory documentation, the system documentation, and the migration description set. In one example, the “user story” may comprise an Agile user story (e.g., according to the Agile Alliance; in other words, a user story in accordance with Agile software development framework). To illustrate, a user story may be a short statement of a problem to be solved, and may generally include a statement of who, what, and why. A user story may be the smallest increment of work to be done in a software project. In other words, a project may be broken down into functional increments called “user stories.” To further illustrate, the “who” may be a stakeholder, owner, role, persona, or the like (which can include automated devices, system, or the like in addition to humans). The “what” can include a desired action. The “why” can include a description of the value of the action or the justification of the result. In one example, the prompt or additional/supplemental prompt content may give one or more examples of archetypical user stories. Thus, while there is no specific required user story format in Agile, the processing system implementing the process 200 may impose some uniformity within user stories based upon the representative examples that may be selected and provided as examples for the ML language model core 290 via the additional content/supplemental prompt content. Another definition for user story in software development is defined as an informal, e.g., natural language, description of features of a software system.

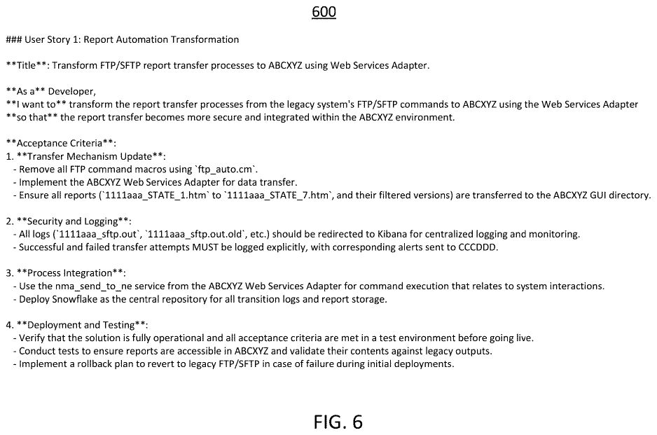

In this regard, FIG. 6 further illustrates an example user story 600 that may be generated by the ML language model core 290 in response to the prompt from the fifth agent 250. In one example, the prompt may request a preferred format, such as the popular “as a . . . I want to . . . so that . . . ” format. For example, the user story 600 may have a title and follow the preferred format to describe that: “**As a** Developer, **I want to** transform the report transfer processes from the legacy system's FTP/SFTP commands to ABCXYZ using the Web Services Adapter, **so that** the report transfer becomes more secure and integrated within the ABCXYZ environment.” The example of FIG. 6 may include further explanatory text such as the “acceptance criteria” that follow the “user story” itself.

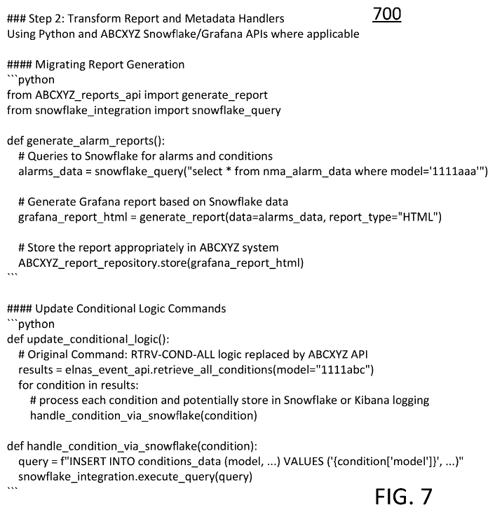

FIG. 2 further illustrates a sixth agent 260 that may be configured to generate a transformed code (e.g., for the target technology platform from the source software package). For instance, the sixth agent 260 may be configured to apply yet another tailored prompt that requests the generation of code replicating the function(s) of the source software package for the target technology platform. In one example, at least one user story generated via the fifth agent 250/ML language model core 290 and at least one constraint of the target technology platform may be provided to the ML language model core 290 along with the prompt of the sixth agent 260. In one example, at least one template for the transformed code is further provided to the ML language model core 290 along with the prompt of the sixth agent 260, e.g., as additional context/supplemental prompt content. For instance, the template may include style formatting preferences, e.g., how to indent, colors to use, naming conventions for functions, variable, inputs, outputs, etc. and so forth. In one example, the contents of the software package may be further provided to the ML language model core 290 along with the prompt of the sixth agent 260, e.g., as additional context/supplemental prompt content. In one example, the contents of the software package may be provided in accordance with at least one of: a RAG process or a chunking process. For instance, the contents of the software package may be chunked to comply with a context window size of the ML language model core 290. An example of generated code snippet 700 that may be output by the ML language model core 290 in response to the prompt of the sixth agent 260 is illustrated in FIG. 7. For instance, this section of code may include transforming “Report and Metadata Handlers” as indicated in the comments of the beginning of the generated code snippet 700.

In addition, it should be noted that the process 200 is just one example of a code transformation process/flow, and that other, further, and different processes and/or components of a same or similar nature may be used in various other examples. To illustrate, one or more of the agents may use a different language model that that which may be used by others of the agents. For instance, different agents may use different fine-tuned language models. It should also be noted that not all agents are necessarily deployed in each instance. To illustrate, in one example, the functions of the third agent 230 and fourth agent 240 may be omitted. In another example, the functions of the sixth agent 260 may be omitted, and so forth. Thus, these and other modifications are all contemplated within the scope of the present disclosure.

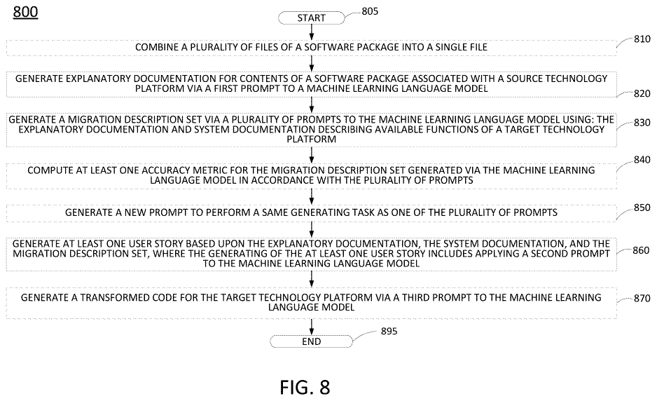

FIG. 8 illustrates a flowchart of an example method 800 for generating via a machine learning language model at least one user story for a transformation of a software package to a target technology platform based on explanatory documentation for the software package and a migration description set generated via the machine learning language model, in accordance with the present disclosure. In one example, steps, functions, and/or operations of the method 800 may be performed by a device as illustrated in FIG. 1, e.g., one or more of the servers 135, or the like, such as a generative MLM-based code transformation platform. Alternatively, or in addition, the steps, functions and/or operations of the method 800 may be performed by a processing system collectively comprising a plurality of devices as illustrated in FIG. 1 such as one or more of the servers 135, DB(s) 136, endpoint devices 111-113 and/or 121-123 (e.g., user equipment (UE), or the like), and so forth. In one example, the steps, functions, or operations of method 800 may be performed by a computing device or system 900, and/or a processing system 902 as described in connection with FIG. 9 below. For instance, the computing device 900 may represent at least a portion of a platform, a server, a system, and so forth, in accordance with the present disclosure. For illustrative purposes, the method 800 is described in greater detail below in connection with an example performed by a processing system. The method 800 begins in step 805 and may proceed to optional step 810 or to step 820.

At optional step 810, the processing system may combine a plurality of files of a software package into a single file, the single file including a meta-data header for each of the plurality of files.

At step 820, the processing system generates explanatory documentation for contents of a software package associated with a source technology platform. For instance, step 820 may include applying a first prompt to a machine learning (ML) language model, where the first prompt requests a generation of the explanatory documentation for the contents of the software package associated with the source technology platform. In addition, step 820 may further include generating the explanatory documentation via the ML language model in accordance with the first prompt. For instance, the ML language model may comprise the core ML language model 290 described above in connection with the example of FIG. 2. As noted above, the ML language model may be a BERT model, a GPT model, a LaMDA model, a PaLM model, or the like. In one example, the contents of the software package may be provided to the ML language model along with the first prompt, e.g., as additional context/supplemental prompt content. It should also be noted that the ML language model may be implemented by the processing system (e.g., the processing system may load into memory and run the code of the ML language model itself). As discussed above, the explanatory documentation may include a description, e.g., a summary of: functionalities of the software package, inputs of the software package, outputs of the software package, and dependencies of the software package. In one example, the explanatory documentation may further include inline comments within lines of code of the software package. In one example, step 820 may include or may be preceded by chunking the single file that may be generated at optional step 810 into chunks in compliance with a content window size limit of the ML language model. In one example, the operations of step 820 may comprise the same or similar operations as described above with respect to the first agent 210 of FIG. 2. In one example, step 820 may be performed via a first AI agent implemented by the processing system (such as the first agent 210 of FIG. 2 or the like) that may be configured to generate explanatory documentation for contents of software packages.

At step 830, the processing system generates a migration description set using: the explanatory documentation and system documentation describing available functions of a target technology platform. For instance, in one example, step 830 may include applying a plurality of prompts to the machine learning language model, wherein the explanatory documentation and the system documentation is provided, e.g., as supplemental prompt content/additional context, to the ML language model along with each prompt of the plurality of prompts. Step 830 may further include generating a plurality of migration description factors of the migration description set via the ML language model in accordance with the plurality of prompts. In one example, each prompt of the plurality of prompts may request a generation of one of the plurality of migration description factors. In one example, the plurality of migration description factors may include: a first migration description factor comprising a summary of the software package (e.g., a one-sentence description or the like), a second migration description factor comprising a mapping of target sources for inputs of the software package in the target technology platform, and a third migration description factor comprising a mapping of target destinations for outputs of the software package in the target technology platform. In one example, the migration description factors may further include at least a fourth migration description factor indicating whether one or more functions of the software package exist in the target technology platform. In one example, the generated migration description set may be added to a target migration table, e.g., that may include a plurality of migration description sets for different software packages. In one example, the operations of step 830 may comprise the same or similar operations as described above with respect to the second agent 220 of FIG. 2. In one example, step 830 may be performed via a second AI agent implemented by the processing system (such as the second agent 220 of FIG. 2 or the like) that may be configured to generate migration description sets.

At optional step 840, the processing system may compute at least one accuracy metric for the migration description set generated via the ML language model in accordance with the plurality of prompts. For instance, the at least one accuracy metric may be for the migration description set as a whole or for at least one of the migration description factors on an individual basis. In one example, the computing of the at least one accuracy metric may be based on at least one sample migration description set with verified migration description factors. In one example, the operations of optional step 840 may comprise the same or similar operations as described above with respect to the agent 230 of FIG. 2. In one example, optional step 840 may be performed via a third AI agent implemented by the processing system (such as the third agent 230 of FIG. 2 or the like) that may be configured to compute accuracy metrics for migration description sets.

At optional step 850, the processing system may generate a new prompt to perform a same generating task as one of the plurality of prompts. For instance, optional step 850 may include applying a (fourth) prompt to the ML language model, the (fourth) prompt requesting the generating of the new prompt, where the one of the plurality of prompts is provided to the ML language model along with the (fourth) prompt, and where the (fourth) prompt requests a generating of the new prompt with an increased accuracy as compared to the one of the plurality of prompts. In addition, It should also be noted that although the terms, “first,” “second,” “third,” “fourth,” etc., are used herein, the use of these terms are intended as labels only. Thus, the use of a term such as “third” in one example does not necessarily imply that the example must in every case include a “first” and/or a “second” of a similar item. In other words, the use of the terms “first,” “second,” “third,” and “fourth,” does not necessarily imply a particular number of those items corresponding to those numerical values. In addition, the use of the term “third” for example, does not imply a specific sequence or temporal relationship with respect to a “first” and/or a “second” of a particular type of item, unless otherwise indicated. In one example, the operations of optional step 850 may comprise the same or similar operations as described above with respect to the fourth agent 240 of FIG. 2. In one example, optional step 850 may be performed via a fourth AI agent implemented by the processing system (such as the fourth agent 240 of FIG. 2 or the like) that may be configured to generate new prompts to replace existing prompts.

At step 860, the processing system generates at least one user story based upon the explanatory documentation, the system documentation, and the migration description set. For instance, step 860 may include applying a second prompt to the ML language model that requests a generation of the at least one user story. In one example, the explanatory documentation, the system documentation, and the migration description set may be provided to the ML language model along with the second prompt. In other words, in one example, the generating of the at least one user story may further include applying the explanatory documentation, the system documentation, and the migration description set as supplemental prompt content/additional context. In one example, a target migration table including a plurality of example migration description sets may be further provided to the ML language model along with the second prompt. In one example, the at least one user story may comprise an Agile user story, e.g., according to the Agile Alliance, such as a user story in accordance with Agile software development recommendations. In one example, the operations of step 860 may comprise the same or similar operations as described above with respect to the fifth agent 250 of FIG. 2. In one example, step 860 may be performed via a fifth AI agent implemented by the processing system (such as the fifth agent 250 of FIG. 2 or the like) that may be configured to generate user stories.

At optional step 870, the processing system may generate a transformed code for the target technology platform via a (third) prompt to the ML language model, where the at least one user story and at least one constraint of the target technology platform are provided to the ML language model along with the (third) prompt, e.g., as supplemental prompt content/additional context. For instance, the template may include style formatting preferences, e.g., how to indent, colors to use, naming conventions for functions, variable, inputs, outputs, etc. and so forth. In one example, the contents of the software package may be further provided to the ML language model along with the (third) prompt, e.g., as supplemental prompt content/additional context. In one example, the contents of the software package may be provided in accordance with at least one of: a RAG process or a chunking process. For instance, the contents of the software package may be chunked to comply with a context window size of the ML language model. In one example, the operations of optional step 870 may comprise the same or similar operations as described above with respect to the sixth agent 260 of FIG. 2. In one example, optional step 870 may be performed via a sixth AI agent implemented by the processing system (such as the sixth agent 260 of FIG. 2 or the like) that may be configured to generate code for use in the target technology platform. Following step 860 or optional step 870, the method 800 ends in step 895.

It should be noted that method 800 may be expanded to include additional steps, or may be modified to replace steps with different steps, to combine steps, to omit steps, to perform steps in a different order, and so forth. For instance, in one example, the processing system may repeat one or more steps of the method 800, such as steps 810-860, steps 820-860, steps 820-870, etc. for additional software packages, for different target technologies, etc. In one example, the method 800 may include obtaining feedback or labels regarding the correctness or validity of migration descriptors, the one or more user stories, and so forth, e.g., which may be used for accuracy computation at step 840 and/or prompt improvement at optional step 850, etc. In one example, the operations of optional step 850 may alternatively or additionally be used to update the first prompt of step 820. In one example, the method 800 may further include obtaining a selection of the software package, presenting the labeled contents of the software package, presenting the at least one user story, presenting the transformed code that is generated, and so forth. For instance, the output(s) such as a user story, transformed code, etc. may be presented via a client user interface (UI), e.g., a graphical user interface (GUI) or the like, associated with the ML language model. In one example, the method 800 may be expanded or modified to include steps, functions, and/or operations, or other features described above in connection with the example(s) of FIGS. 1-7, or as described elsewhere herein. Thus, these and other modifications are all contemplated within the scope of the present disclosure.

In addition, although not specifically specified, one or more steps, functions, or operations of the method 800 may include a storing, displaying, and/or outputting step as required for a particular application. In other words, any data, records, fields, and/or intermediate results discussed in the method 800 can be stored, displayed and/or outputted either on the device executing the method 800, or to another device, as required for a particular application. Furthermore, steps, blocks, functions, or operations in FIG. 8 that recite a determining operation or involve a decision do not necessarily require that both branches of the determining operation be practiced. In other words, one of the branches of the determining operation can be deemed as an optional step. In addition, one or more steps, blocks, functions, or operations of the above described method 800 may comprise optional steps, or can be combined, separated, and/or performed in a different order from that described above, without departing from the examples of the present disclosure.

FIG. 9 depicts a high-level block diagram of a computing device or processing system specifically programmed to perform the functions described herein. For example, any one or more components or devices illustrated in FIG. 1 or described in connection with the example(s) of FIG. 2-8 may be implemented as the processing system 900. As depicted in FIG. 9, the processing system 900 comprises one or more hardware processor elements 902 (e.g., a microprocessor, a central processing unit (CPU) and the like), a memory 904, (e.g., random access memory (RAM), read only memory (ROM), a disk drive, an optical drive, a magnetic drive, and/or a Universal Serial Bus (USB) drive), a module 905 for generating via a machine learning language model at least one user story for a transformation of a software package to a target technology platform based on explanatory documentation for the software package and a migration description set generated via the machine learning language model, and various input/output devices 906, e.g., a camera, a video camera, storage devices, including but not limited to, a tape drive, a floppy drive, a hard disk drive or a compact disk drive, a receiver, a transmitter, a speaker, a display, a speech synthesizer, an output port, and a user input device (such as a keyboard, a keypad, a mouse, and the like).

Although only one processor element is shown, it should be noted that the computing device may employ a plurality of processor elements. Furthermore, although only one computing device is shown in FIG. 9, if the method(s) as discussed above is implemented in a distributed or parallel manner for a particular illustrative example, i.e., the steps of the above method(s) or the entire method(s) are implemented across multiple or parallel computing devices, e.g., a processing system, then the computing device of FIG. 9 is intended to represent each of those multiple computing devices. Furthermore, one or more hardware processors can be utilized in supporting a virtualized or shared computing environment. The virtualized computing environment may support one or more virtual machines representing computers, servers, or other computing devices. In such virtualized virtual machines, hardware components such as hardware processors and computer-readable storage devices may be virtualized or logically represented. The hardware processor 902 can also be configured or programmed to cause other devices to perform one or more operations as discussed above. In other words, the hardware processor 902 may serve the function of a central controller directing other devices to perform the one or more operations as discussed above.

It should be noted that the present disclosure can be implemented in software and/or in a combination of software and hardware, e.g., using application specific integrated circuits (ASIC), a programmable logic array (PLA), including a field-programmable gate array (FPGA), or a state machine deployed on a hardware device, a computing device, or any other hardware equivalents, e.g., computer readable instructions pertaining to the method(s) discussed above can be used to configure a hardware processor to perform the steps, functions and/or operations of the above disclosed method(s). In one example, instructions and data for the present module or process 905 for generating via a machine learning language model at least one user story for a transformation of a software package to a target technology platform based on explanatory documentation for the software package and a migration description set generated via the machine learning language model (e.g., a software program comprising computer-executable instructions) can be loaded into memory 904 and executed by hardware processor element 902 to implement the steps, functions or operations as discussed above in connection with the example method(s). Furthermore, when a hardware processor executes instructions to perform “operations,” this could include the hardware processor performing the operations directly and/or facilitating, directing, or cooperating with another hardware device or component (e.g., a co-processor and the like) to perform the operations.

The processor executing the computer readable or software instructions relating to the above described method(s) can be perceived as a programmed processor or a specialized processor. As such, the present module 905 for generating via a machine learning language model at least one user story for a transformation of a software package to a target technology platform based on explanatory documentation for the software package and a migration description set generated via the machine learning language model (including associated data structures) of the present disclosure can be stored on a tangible or physical (broadly non-transitory) computer-readable storage device or medium, e.g., volatile memory, non-volatile memory, ROM memory, RAM memory, magnetic or optical drive, device or diskette and the like. Furthermore, a “tangible” computer-readable storage device or medium comprises a physical device, a hardware device, or a device that is discernible by the touch. More specifically, the computer-readable storage device may comprise any physical devices that provide the ability to store information such as data and/or instructions to be accessed by a processor or a computing device such as a computer or an application server.

While various embodiments have been described above, it should be understood that they have been presented by way of example only, and not limitation. Thus, the breadth and scope of a preferred embodiment should not be limited by any of the above-described example embodiments, but should be defined only in accordance with the following claims and their equivalents.

What is claimed is:

1. A method comprising:
generating, by a processing system including at least one processor, an explanatory documentation for content of a software package associated with a source technology platform, wherein the generating of the explanatory documentation comprises:
applying a first prompt to a machine learning language model, wherein the first prompt requests a generation of the explanatory documentation for the content of the software package associated with the source technology platform; and
generating the explanatory documentation via the machine learning language model in accordance with the first prompt;
generating, by the processing system, a migration description set using: the explanatory documentation and a system documentation describing available functions of a target technology platform, wherein the generating of the migration description set comprises:
applying a plurality of prompts to the machine learning language model, wherein the explanatory documentation and the system documentation are provided to the machine learning language model along with each prompt of the plurality of prompts; and
generating a plurality of migration description factors of the migration description set via the machine learning language model in accordance with the plurality of prompts, wherein each prompt of the plurality of prompts requests a generation of one of the plurality of migration description factors, wherein the plurality of migration description factors includes: a first migration description factor comprising a summary of the software package, a second migration description factor comprising a mapping of target sources for inputs of the software package in the target technology platform, and a third migration description factor comprising a mapping of target destinations for outputs of the software package in the target technology platform; and
generating, by the processing system, at least one user story based upon the explanatory documentation, the system documentation, and the migration description set, wherein the generating of the at least one user story includes applying a second prompt to the machine learning language model that requests a generation of the at least one user story, wherein the explanatory documentation, the system documentation, and the migration description set are provided to the machine learning language model along with the second prompt.

2. The method of claim 1, wherein the content of the software package is provided to the machine learning language model along with the first prompt.

3. The method of claim 1, wherein the explanatory documentation includes a description of:
functionalities of the software package;
inputs of the software package;
outputs of the software package; and
dependencies of the software package.

4. The method of claim 1, wherein the explanatory documentation further includes:
inline comments within lines of code of the software package.

5. The method of claim 1, further comprising:
combining a plurality of files of the software package into a single file, the single file including a meta-data header for each of the plurality of files, wherein the applying comprises chunking the single file into chunks in compliance with a content window size limit of the machine learning language model.

6. The method of claim 1, wherein a target migration table including a plurality of example migration description sets is further provided to the machine learning language model along with the second prompt.

7. The method of claim 6, wherein the migration description set is added to the target migration table.

8. The method of claim 1, further comprising:
generating, by the processing system, a transformed code for the target technology platform via a third prompt to the machine learning language model, wherein the at least one user story and at least one constraint of the target technology platform are provided to the machine learning language model along with the third prompt.

9. The method of claim 8, wherein at least one template for the transformed code is further provided to the machine learning language model along with the third prompt.

10. The method of claim 8, wherein the content of the software package is further provided to the machine learning language model along with the third prompt.

11. The method of claim 10, wherein the content of the software package is provided to the machine learning language model along with the third prompt in accordance with at least one of: a retrieval augmented generation process or a chunking process.

12. The method of claim 1, further comprising:
computing at least one accuracy metric for the migration description set generated via the machine learning language model in accordance with the plurality of prompts.

13. The method of claim 12, wherein the at least one accuracy metric is for the migration description set as a whole or for at least one of the migration description factors on an individual basis.

14. The method of claim 12, wherein the computing of the at least one accuracy metric is based on at least one sample migration description set with verified migration description factors.

15. The method of claim 12, further comprising:
generating a new prompt to perform a same generating task as one of the plurality of prompts, wherein the generating of the new prompt comprises applying a fourth prompt to the machine learning language model, the fourth prompt requesting the generating of the new prompt, where the one of the plurality of prompts is provided to the machine learning language model along with the fourth prompt, and where the fourth prompt requests a generating of the new prompt with an increased accuracy as compared to the one of the plurality of prompts.

16. The method of claim 1, wherein the at least one user story comprises an agile user story.

17. The method of claim 1, wherein the machine learning language model is implemented by the processing system.

18. The method of claim 1, wherein the machine learning language model comprises:
a bidirectional encoder representations from transformers model;
a generative pre-training model;
a language model for dialogue applications model; or
a pathways language model.

19. A non-transitory computer-readable medium storing instructions which, when executed by a processing system including at least one processor, cause the processing system to perform operations, the operations comprising:
generating an explanatory documentation for content of a software package associated with a source technology platform, wherein the generating of the explanatory documentation comprises:
applying a first prompt to a machine learning language model, wherein the first prompt requests a generation of the explanatory documentation for the content of the software package associated with the source technology platform; and
generating the explanatory documentation via the machine learning language model in accordance with the first prompt;
generating a migration description set using: the explanatory documentation and a system documentation describing available functions of a target technology platform, wherein the generating of the migration description set comprises:
applying a plurality of prompts to the machine learning language model, wherein the explanatory documentation and the system documentation are provided to the machine learning language model along with each prompt of the plurality of prompts; and
generating a plurality of migration description factors of the migration description set via the machine learning language model in accordance with the plurality of prompts, wherein each prompt of the plurality of prompts requests a generation of one of the plurality of migration description factors, wherein the plurality of migration description factors includes: a first migration description factor comprising a summary of the software package, a second migration description factor comprising a mapping of target sources for inputs of the software package in the target technology platform, and a third migration description factor comprising a mapping of target destinations for outputs of the software package in the target technology platform; and
generating at least one user story based upon the explanatory documentation, the system documentation, and the migration description set, wherein the generating of the at least one user story includes applying a second prompt to the machine learning language model that requests a generation of the at least one user story, wherein the explanatory documentation, the system documentation, and the migration description set are provided to the machine learning language model along with the second prompt.

20. An apparatus comprising:
a processing system including at least one processor; and
a computer-readable medium storing instructions which, when executed by the processing system, cause the processing system to perform operations, the operations comprising:
generating an explanatory documentation for content of a software package associated with a source technology platform, wherein the generating of the explanatory documentation comprises:
applying a first prompt to a machine learning language model, wherein the first prompt requests a generation of the explanatory documentation for the content of the software package associated with the source technology platform; and
generating the explanatory documentation via the machine learning language model in accordance with the first prompt;
generating a migration description set using: the explanatory documentation and a system documentation describing available functions of a target technology platform, wherein the generating of the migration description set comprises:
applying a plurality of prompts to the machine learning language model, wherein the explanatory documentation and the system documentation are provided to the machine learning language model along with each prompt of the plurality of prompts; and
generating a plurality of migration description factors of the migration description set via the machine learning language model in accordance with the plurality of prompts, wherein each prompt of the plurality of prompts requests a generation of one of the plurality of migration description factors, wherein the plurality of migration description factors includes: a first migration description factor comprising a summary of the software package, a second migration description factor comprising a mapping of target sources for inputs of the software package in the target technology platform, and a third migration description factor comprising a mapping of target destinations for outputs of the software package in the target technology platform; and
generating at least one user story based upon the explanatory documentation, the system documentation, and the migration description set, wherein the generating of the at least one user story includes applying a second prompt to the machine learning language model that requests a generation of the at least one user story, wherein the explanatory documentation, the system documentation, and the migration description set are provided to the machine learning language model along with the second prompt.
